(19) United States
(12) Patent Application Publication
(10) Pub. No.: US 2022/0295697 A1
(43) Pub. Date: Sep. 22, 2022

(54) WORKING SYSTEM AND CHARGE STATION

(71) Applicant: Honda Motor Co., Ltd., Tokyo (JP)

(72) Inventor: Junichi Eguchi, Wako-shi (JP)

(21) Appl. No.: 17/684,223

(22) Filed: Mar. 1, 2022

(30) Foreign Application Priority Data
Mar. 17, 2021 (JP) 2021-043966

(51) Int. Cl. A01D 34/00; G05D 1/02; B60L 53/30; H02J 7/00

(52) U.S. Cl. CPC A01D 34/008; G05D 1/0225; G05D 1/0287; G05D 1/028; B60L 53/305; H02J 7/0044; G05D 2201/0208; A01D 2101/00

(57) ABSTRACT

A working system includes: a plurality of working machine each configured to autonomously travel in a work area to work using an electric equipment mounted thereon; a standby station provided in the work area, in which each of the plurality of working machine is docked; a signal generator configured to generate a signal for each of the plurality of working machine to set its travel route; a determining unit configured to determine whether all of the plurality of working machine are docked in the standby station; and a managing unit configured to restrict operation of the signal generator when it is determined by the determining unit that all of the plurality of working machine are docked in the standby station.

### CROSS-REFERENCE TO RELATED APPLICATION

This application is based upon and claims the benefit of priority from Japanese Patent Application No. 2021-043966 filed on Mar. 17, 2021, the content of which is incorporated herein by reference.

### BACKGROUND OF THE INVENTION

### Field of the Invention

This invention relates to a working system including working machines autonomously traveling and working in a work area and standby (charge) stations for charging electric equipment mounted on the working machines.

### Description of the Related Art

Conventionally, as this type of apparatus, there is a known apparatus described in Japanese Unexamined Patent Publication No. 2020-156289 (JP2020-156289A), for example. The apparatus described in JP2020-156289A is configured to calculate a cutoff period of the supply power supplied from a standby station and cutting off the supply according to the cutoff period to reduce power consumption.

The apparatus described in JP2020-156289A assumes a working system including one working machine and one standby (charge) station in one work area. Hence, there has been no proposal for reducing the power consumption in the working system in which a plurality of working machines and a plurality of standby stations are prepared in one work area.

The present invention provides a working system for reducing power consumption in a case in which a plurality of working machines and a plurality of standby stations are provided in one work area.

### SUMMARY OF THE INVENTION

An aspect of the present invention is a working system, including: a plurality of working machine each configured to autonomously travel in a work area to work using an electric equipment mounted thereon; a standby station provided in the work area, in which each of the plurality of working machine is docked; a signal generator configured to generate a signal for each of the plurality of working machine to set its travel route; a determining unit configured to determine whether all of the plurality of working machine are docked in the standby station; and a managing unit configured to restrict operation of the signal generator when it is determined by the determining unit that all of the plurality of working machine are docked in the standby station.

Another aspect of the present invention is a charge station provided in a work area and configured to charge each of a plurality of working machine docked in the charge station, each of the plurality of working machine being configured to autonomously travel in the work area to work using an electric equipment mounted thereon. The charge station includes: a signal generator configured to generate a signal for each of the plurality of working machine to set its travel route; a determining unit configured to determine whether all of the plurality of working machine are docked in the standby station; and a managing unit configured to restrict operation of the signal generator when it is determined by the determining unit that all of the plurality of working machine are docked in the standby station.

### BRIEF DESCRIPTION OF THE DRAWINGS

The objects, features, and advantages of the present invention will become clearer from the following description of embodiments in relation to the attached drawings, in which:

FIG. 1 is a top view schematically showing overall configuration of a working system according to a first embodiment of the present invention;

FIG. 2 is a side view schematically showing overall configuration of a working machine autonomously traveling of FIG. 1;

FIG. 3 is a top view of the working machine autonomously traveling of FIG. 2;

FIG. 4 is a block diagram showing a control configuration of the working system according to the first embodiment of the present invention;

FIG. 5 is a block diagram showing a schematic configuration of a standby station of FIG. 1;

FIG. 6 is a diagram showing an example of a waveform of a current outputted from the standby station of FIG. 5 to an area wire;

FIG. 7 is a diagram showing a relationship between a distance from the area wire to the working machine autonomously traveling of FIG. 5 and magnetic field strength;

FIG. 8A is a top view showing a modification of the work areas of FIG. 1;

FIG. 8B is a top view showing another modification of the work areas of FIG. 1;

FIG. 8C is a top view showing a further modification of the work areas of FIG. 1;

FIG. 9 is a flowchart showing an example of a process performed by the working system according to the first embodiment of the present invention;

FIG. 10 is a top view schematically showing overall configuration of a working system according to a second embodiment of the present invention;

FIG. 11 is a flowchart showing an example of a process performed by the working system according to the second embodiment of the present invention;

FIG. 12 is a top view schematically showing overall configuration of a working system according to a third embodiment of the present invention;

FIG. 13 is a flowchart showing an example of a process performed by the working system according to the third embodiment of the present invention;

FIG. 14 is a top view schematically showing overall configuration of a working system according to a fourth embodiment of the present invention;

FIG. 15 is a flowchart showing an example of a process performed by the working system according to the fourth embodiment of the present invention;

FIG. 16 is a top view schematically showing overall configuration of a working system according to a fifth embodiment of the present invention; and

FIG. 17 is a top view schematically showing overall configuration of a working system according to a sixth embodiment of the present invention.

### DETAILED DESCRIPTION OF THE INVENTION

### First Embodiment

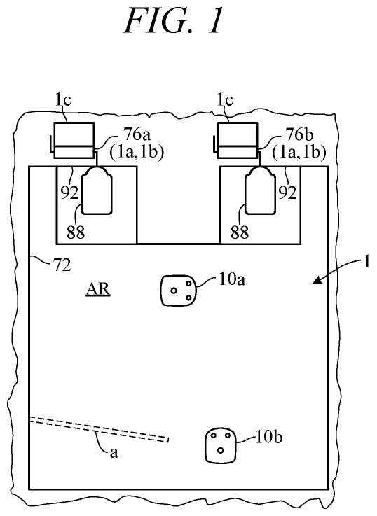

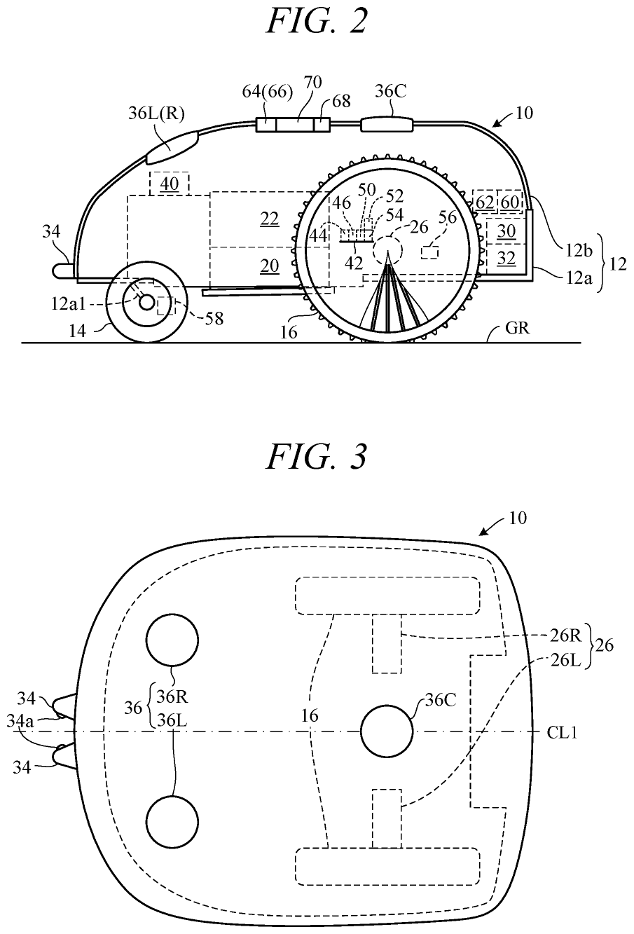

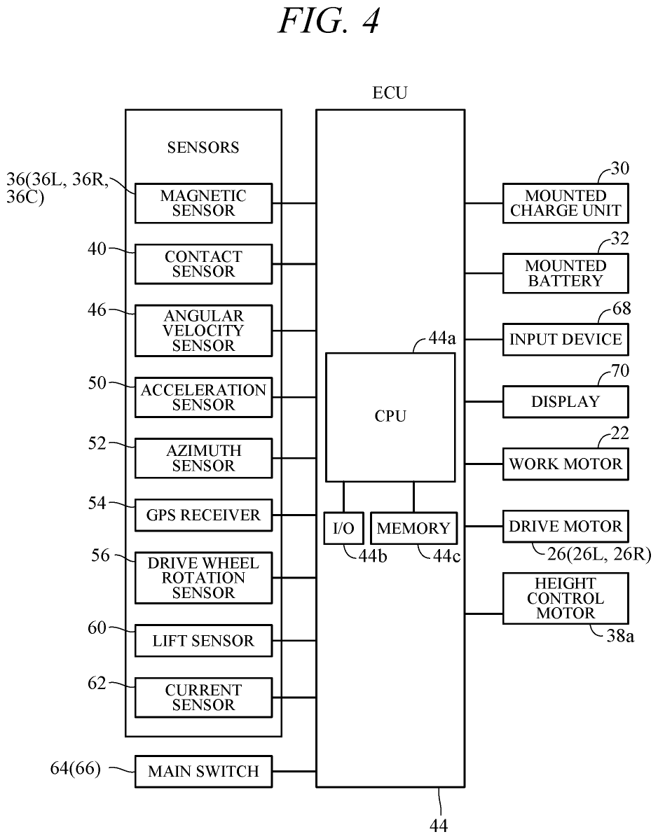

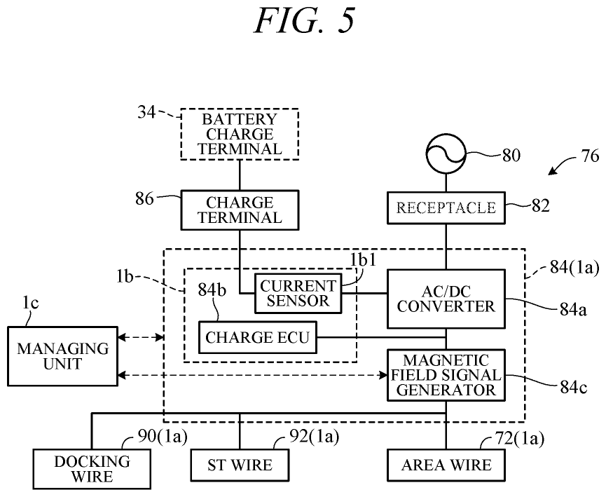

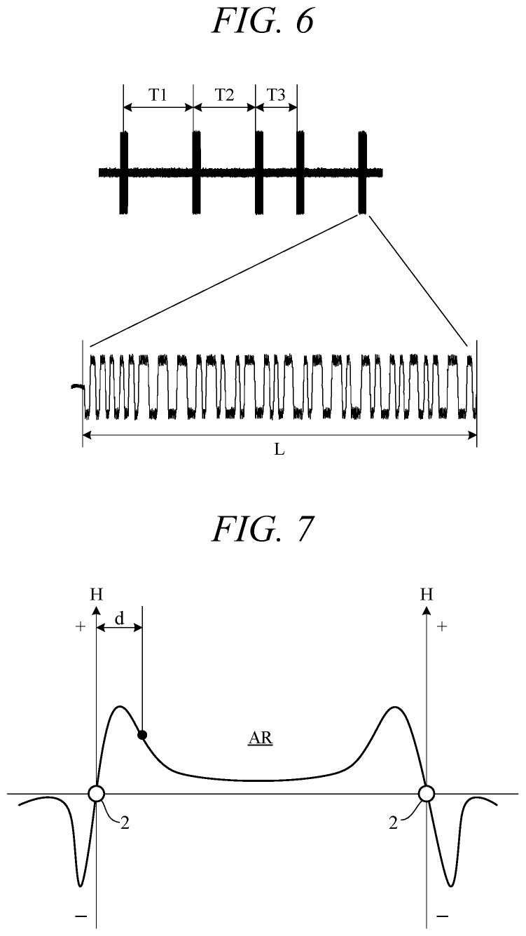

FIG. 1 is a top view schematically showing an overall configuration of a working system 1 according to a first embodiment of the present invention. FIG. 2 is a side view schematically showing the overall configuration of the working machine autonomously traveling of FIG. 1. FIG. 3 is a top view of the working machine autonomously traveling of FIG. 2. FIG. 4 is a block diagram showing a control configuration of the working system according to the first embodiment of the present invention. FIG. 5 is a block diagram showing a schematic configuration of a standby station of FIG. 1. FIG. 6 is a diagram showing an example of a waveform of a current outputted from the standby station of FIG. 5 to an area wire. FIG. 7 is a diagram showing a relationship between a distance from the area wire to the working machine autonomously traveling of FIG. 5 and magnetic field strength.

In the working system 1 of FIG. 1, a working machine autonomously traveling (hereinafter, referred to as “working machine”) 10 autonomously travels in a work area AR, and works operating a work tool by electric equipment mounted thereon.

As shown in FIG. 2, the working machine 10 specifically consists of a lawn mower. The working machine 10 includes a body (vehicle body) 12, and the body 12 is configured by a chassis 12a and a frame 12b mounted thereon.

In the following description, the travel direction (length direction) of the working machine 10, the lateral direction (width direction) perpendicular thereto, and the vertical direction perpendicular to the travel direction and lateral direction are defined as the front-rear direction, left-right direction, and up-down direction, respectively. The configuration of the components will be described in accordance with this definition.

The working machine 10 includes a pair of left and right front wheels 14 that have a relatively small diameter and are fixed to the front side of the chassis 12a through stays 12a1, as well as a pair of left and right rear wheels 16 that have a relatively large diameter and are directly mounted on the rear side of the chassis 12a so as to be adjacent to the front wheels 14. One or both of the rear wheels 16 and front wheels 14 need not be of a wheel type as shown and may be of a crawler (caterpillar) type.

A lawn mowing blade, that is, a rotary blade 20 is mounted to the vicinity of the central position of the chassis 12a of the working machine 10 as a work tool. An electric motor (hereafter also referred to as “work motor”) 22 is disposed as electric equipment on an upper position of the blade 20. As shown in FIG. 2, the blade 20 is attached to the frame 12b such that a front portion thereof is lowered in the forward direction of the working machine 10.

A pair of electric motors (hereafter referred to as “drive motors”) 26L and 26R as prime movers are mounted on the chassis 12a of the working machine 10 so as to be close to the rear end of the blade 20. The drive motors 26L and 26R are connected to the left and right rear wheels 16 and independently rotate them in a forward rotation (normal rotation) or in a backward rotation (reverse rotation) using the front wheels 14 as driven wheels and the rear wheels 16 as drive wheels. The blade 20, the work motor 22, the drive motors 26, and the like are covered by the frame 12b.

The working machine 10 has a weight and sizes such that a user can carry it. As an example, the working machine 10 has an overall length (the length in the front-rear direction) of about 71 cm, an overall width of about 55 cm, and a height of about 30 cm.

A mounted charge unit 30 and a mounted battery 32 (battery) are stored in a rear portion of the working machine 10. A pair of battery charge terminals 34 are mounted on the front end of the frame 12b in the forward direction so as to protrude forward. For example, the mounted battery 32 is configured by a lithium-ion battery.

The battery charge terminals 34 are connected to the mounted charge unit 30 through wiring. The mounted charge unit 30 is connected to the mounted battery 32. The work motor 22 and drive motors 26 are also connected to the mounted battery 32 so that a current is passed thereto by the mounted battery 32. The wiring is not shown in FIG. 1.

A pair of left and right magnetic sensors (first magnetic sensor 36L, second magnetic sensor 36R) are disposed on the front side of the body 12 of the working machine 10, and one third magnetic sensor 36C is disposed on the rear side thereof. Each sensor outputs a signal indicating the magnitude of a magnetic field (magnetic field strength). As shown in FIG. 2, the first and second magnetic sensors 36L and 36R are disposed on the front side of the body 12 of the working machine 10 and in positions symmetrical in the left-right direction with respect to a body center line CL1 extending in the front-rear direction, and the third magnetic sensor 36C is disposed on the body center line CL1.

As shown in FIG. 2, the blade 20 and the work motor 22 are provided with a blade height adjustment mechanism 38. The height in the up-down direction of the blade 20 with respect to the ground surface GR can be controlled by the blade height adjustment mechanism 38.

A contact sensor 40 is mounted on the frame 12b of the body 12 of the working machine 10. The contact sensor 40 outputs an ON-signal when the frame 12b comes off the chassis 12a due to contact with an obstacle or foreign object.

In FIG. 2, a housing box (not shown) is disposed near the central position of the working machine 10, and an electronic control unit (hereafter referred to as “ECU”) 44 consisting of a microcomputer serving as a controller is mounted on a circuit board 42 housed in the housing box. As shown in FIG. 4, the ECU 44 includes a central processing unit (CPU) 44a, an input/output interface (I/O) 44b, and a memory 44c, such as read only memory (ROM), electrically erasable programmable read-only memory (EEPROM), or random access memory (RAM).

As shown in FIG. 2, an angular velocity sensor 46 that is adjacent to the ECU 44 and generates an output indicating the angular velocity (yaw rate) around a z-axis (vertical axis) in the gravity center of the working machine 10, an acceleration sensor 50 that generates an output indicating acceleration during travel of the working machine 10, an azimuth sensor 52 that generates an output indicating the absolute azimuth corresponding to the terrestrial magnetism, and a global positioning system (GPS) receiver 54 that receives a signal from a GPS satellite and generates an output indicating the current position (latitude, longitude) of the working machine 10 are disposed on the circuit board 42.

A drive wheel rotation sensor 56 that generates an output indicating the rotation speed of the left and right rear wheels 16 (wheel speed) is disposed near the left and right rear wheels 16 of the working machine 10. A lift sensor 60 that outputs an ON-signal, when the frame 12b is lifted from the chassis 12a by a user or the like is disposed between the chassis 12a and frame 12b. A current sensor 62 that generates an output indicating the current consumption of the mounted battery 32 is disposed on the mounted battery 32.

A main switch 64 for issuing a work start command or the like and an emergency stop switch 66 for issuing an emergency stop command are disposed on the working machine 10 so as to be operable by the user. The upper surface of the frame 12b of the working machine 10 is greatly notched, and an input device 68, such as a keyboard or touchscreen, for inputting a user command or the like and a display 70 are disposed in the notch. The input device 68 and the display 70 are connected to the ECU 44, and various types of information, such as a work mode, are displayed on the display 70 in accordance with a command of the ECU 44.

As shown in FIG. 4, signals from the sensors, such as the magnetic sensor 36, the contact sensor 40, and the angular velocity sensor 46, and signals from the switches, such as the main switch 64, are inputted to the ECU 44 through the I/O 44b. The ECU 44 (CPU 44a) controls the travel and work of the working machine 10 by outputting control signals to the work motor 22 and the drive motors 26 through the I/O 44b on the basis of these signals and thus controlling the operation of these components.

The ECU 44 also controls the height of the blade 20 with respect to the ground surface GR by outputting a control signal to a height control motor 38a and thus automatically raising or lowering the blade 20 in the up-down direction along with the work motor 22.

The drive motors 26L and 26R are configured to be able to independently rotate the left and right rear wheels 16 forward (normal rotation) or backward (reverse rotation), as well as is configured to turn the working machine 10 in any direction by making a difference between the rotation speeds of the left and right rear wheels 16.

For example, if the left and right rear wheels 16 are rotated forward such that the right rear wheel 16 rotates at a higher speed than the left rear wheel 16, the working machine 10 turns to the left at a turn angle corresponding to the speed difference. On the other hand, if the left rear wheel 16 is rotated at a higher speed than the right rear wheel 16, the working machine 10 turns to the right at a turn angle corresponding to the speed difference. If one of the left and right rear wheels 16 and the other are rotated forward and backward, respectively, at the same speed, the working machine 10 turns at that site without moving forward and backward.

The work area AR is defined by an area wire (electric wire) 72 disposed, for example, buried in a peripheral edge (boundary) of a work target ground such as a garden. The ECU 44 detects (recognizes) the work area AR from the outputs of the sensors, in particular, outputs of the magnetic sensor 36. The ECU 44 then passes a current through the work motor 22 on the basis of the detected work area AR so that the working machine 10 works in the work area AR.

The area wire 72 is disposed at a peripheral edge of the work target ground. As indicated by a reference sign a in FIG. 1, the area wire 72 may be disposed so as to be branched in a partway and protrude to the inside of the work area AR and then returned to the original peripheral edge, that is, may be disposed in at least a part of the work area AR.

In the work area AR, a standby station (hereinafter referred to as “standby ST”) 76 for charging the mounted battery 32 of the working machine 10 is disposed. In FIGS. 1 and 5, the sizes of the working machines 10 and the standby STs 76 are shown in a magnified manner.

FIG. 5 is a block diagram showing an electrical configuration of the standby ST 76.

As shown in FIG. 5, the standby ST 76 includes a charger 84 connected to a power supply (commercial power supply) 80 through a receptacle 82 and a pair of charge terminals 86 connected to the charger 84. The charge terminals 86 are configured to be connectable to the pair of battery charge terminals 34 mounted on the working machine 10 through contacts 34a (FIG. 3). The standby ST 76 includes a placing table 88. When the working machine 10 is placed on the placing table 88, charge is conducted between the charge terminal 86 and the battery charge terminal 34.

The charger 84 includes an AC/DC converter 84a, a charge ECU (electronic control unit) 84b consisting of a microcomputer that controls the operation of the AC/DC converter 84a, and a magnetic field signal generator 84c.

In the standby ST 76, the AC/DC converter 84a of the charger 84 converts an alternating current supplied from the power supply 80 through the receptacle 82 into a direct current while reducing the voltage to a proper voltage and then outputs the direct current to the charge terminals 86. When the working machine 10 that returns to the standby ST 76 and is placed on the placing table 88 connects (docks) therewith through the charge terminal 86 and the battery charge terminal 34, the mounted battery 32 of the working machine 10 is charged.

The output of the AC/DC converter 84a is supplied to the magnetic field signal generator 84c and the charge ECU 84b. The charge ECU 84b is configured to be able to communicate with the ECU 44, and the operation of the magnetic field signal generator 84c is controlled in accordance with a command of the ECU 44.

The magnetic field signal generator 84c converts the direct current, whose voltage has been reduced to the proper voltage by the AC/DC converter 84a, into a predetermined signal in accordance with the command issued from the ECU 44 to the charge ECU 84b. The magnetic field signal generator 84c outputs the signal to the area wire 72, a docking wire (electric wire) 90 (not shown in FIG. 1) indicating the docking position in the standby ST 76, and an ST wire (electric wire) 92 indicating the standby ST 76.

FIG. 6 is a diagram showing an example of a waveform of a current outputted from the magnetic field signal generator 84c to the area wire 72. For example, the current waveform has a signal length of L and is outputted in arbitrary cycle Tn. A regular current waveform may be outputted in a predetermined cycle. Although not shown, the magnetic field signal generator 84c passes the current such that the same type of current waveforms (different in phase) occur in the docking wire 90 and the ST wire 92.

When the magnetic field signal generator 84c passes the current as shown in FIG. 6 through the area wire 72, a clockwise, concentric circular magnetic field occurs around the area wire 72 in accordance with the Ampere's right-handed screw rule. The magnetic field strength varies with the overall length of the area wire 72 and the distance between the working machine 10 and the area wire 72.

FIG. 7 is a diagram showing the relationship between the distance d from the area wire 72 to the working machine 10 and the magnetic field strength H. As shown in FIG. 7, the magnetic field strength H varies with the distance d from the area wire 72, and the value becomes 0 on the area wire 72, positive inside the work area AR, and negative outside the work area AR.

The ECU 44 detects the strength of the magnetic field (area signal) generated by passing the current through the area wire 72, using the magnetic sensors 36 mounted on the working machine 10. Thus, the ECU 44 determines the position of the working machine (subject machine) 10 in the work area AR, that is, determines whether the working machine 10 is located inside or outside the work area AR, as well as detects (calculates) the position of the working machine 10 with respect to the area wire 72 (the distance from the area wire 72).

More specifically, the ECU 44 detects the magnetic field of the area wire 72 using the magnetic sensor 36 to detect the position of the area wire 72, as well as detects the relative position of the working machine 10 with respect to the area wire 72 in the work area AR from the outputs of the drive wheel rotation sensor 56, the angular velocity sensor 46, the acceleration sensor 50, and the azimuth sensor 52. At this time, the output of the GPS receiver 54 may be used in a supplemental manner. The GPS receiver 54 may be of a satellite positioning system type using a satellite other than GPS satellites, such as a global navigation satellite system (GNSS) or a regional navigation satellite system (RNSS).

The working system 1 includes a signal generator 1a that generates a signal for the working machine 10 to set its route, a state detecting unit 1b that detects that the working machine 10 is placed on the standby ST 76, and a managing unit 1c that restricts an operation of the signal generator 1a when the state detecting unit 1b detects that all (m) of the working machines 10 are placed on the standby STs 76.

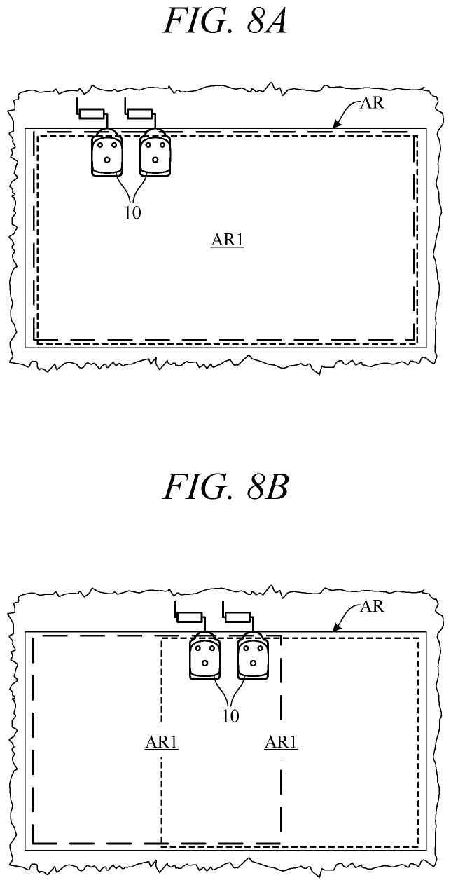

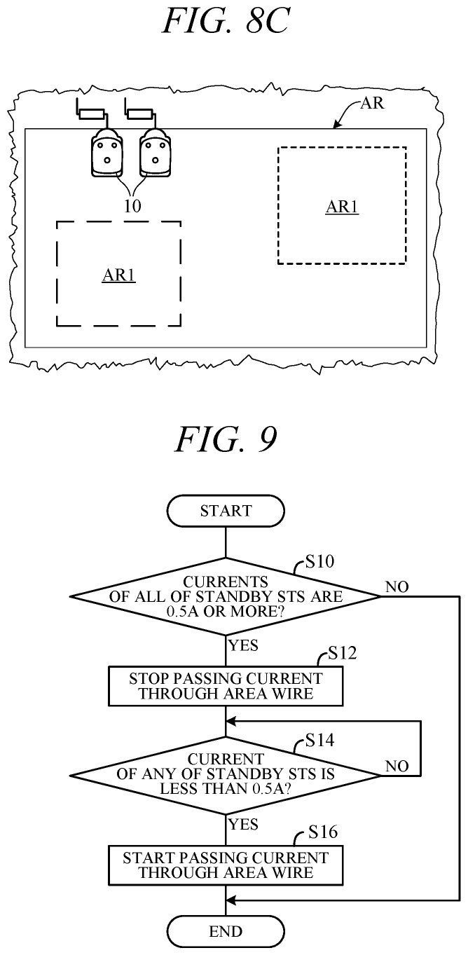

The number of the work areas AR is not limited to one as shown in FIG. 1, and a plurality of work areas AR may be provided. For example, as shown in FIGS. 8A to 8C, a plurality of second work areas AR1 may be included in the first work area AR. The plurality of second work areas AR1 may be provided so as to entirely overlap as shown in FIG. 8A, may be provided so as to partially overlap as shown in FIG. 8B, or may be provided so as not to overlap as shown in FIG. 8C.

The number (n) of the standby STs 76 may be the same as the number (m) of the working machines 10 in the work area AR (n=m). The number (n) of the standby STs 76 may be greater (n>m) or may be smaller (n<m) than the number (m) of the working machines 10. In addition, a plurality of working machines 10 may stand by in one standby ST 76. In FIG. 1, as an example, two working machines 10 (10a, 10b) and two standby STs 76 (76a, 76b) are shown (n=m).

The signal generator 1a includes the charger 84 of the standby ST 76, the area wire 72, the docking wire 90, and the ST wire 92.

The state detecting unit 1b includes the charge ECU 84b of the charger 84, and a current sensor 1b1 disposed in a current passing circuit of the AC/DC converter 84a and the charge terminal 86. The state detecting unit 1b detects that the working machine 10 is placed on the standby ST 76 from the detected current value.

The managing unit 1c is disposed in the standby ST 76. The managing unit 1c may be accommodated in a box body provided in or near the work area AR. The managing unit 1c is constituted of a computer, and includes a CPU, an I/O, and a memory, similarly to the ECU 44. The managing unit 1c is configured to be mutually connectable to the signal generator 1a and the charge ECU 84b of the state detecting unit 1b.

FIG. 9 is a flowchart showing an example of a process performed by the working system 1 according to the first embodiment of the present invention, and is a flowchart showing an example of a process performed by the state detecting unit 1b (charge ECU 84b and the like) according to a predetermined program.

As shown in FIG. 9, first, in S10 (S means a process step), it is determined whether currents passed from the charge terminals 86 of all of the standby STs 76a and 76b through the battery charge terminals 34 are 0.5 A or more. If the determination in S10 is NO, the process ends. If the determination in S10 is YES, the process proceeds to S12, and stops passing the current through the area wire 72 and the like in accordance with a command from the managing unit 1c so as to restrict the operation of the signal generator 1a.

Next, the process proceeds to S14, and it is determined whether the current passed from the charge terminal 86 of one of the standby STs 76a and 76b through the battery charge terminal 34 is less than 0.5 A. S14 is repeated until it is affirmed. If the determination in S14 is YES, the process proceeds to S16, and starts (or restarts) passing the current through the area wire 72 and the like in accordance with a command from the managing unit 1c so as to release the operation restriction of the signal generator 1a.

When the working machine 10 returns to the standby ST and connects (docks) therewith through the charge terminal 86 and the battery charge terminal 34, a current of 0.5 A or more flows from the charge terminal 86 to the battery charge terminal 34 of the working machine 10 regardless of the presence or absence of charge. Thus, if the currents passed from all of the standby STs 76a and 76b are 0.5 A or more, all of the working machines 10a and 10b are docked in the standby STs 76 and are not located in the work area AR. In this case, passing the current through the area wire 72 for position recognition is stopped and the operation of the signal generator 1a is restricted, which makes it possible to effectively reduce the power consumption. At this time, the current passed through the docking wire 90 and the ST wire 92 may also be stopped. In this case, the power consumption can be more effectively reduced.

On the other hand, if the current passed from one of the standby STs 76a and 76b is less than 0.5 A, one of the working machines 10a and 10b is not docked in the standby ST 76 and is located in the work area AR. In this case, passing the current through the area wire 72 for position recognition and the like is started and the operation restriction of the signal generator 1a is released, which makes it possible to prevent trouble from occurring during travel of the working machine 10 located in the work area AR.

The first embodiment can achieve advantageous effects as follows.

A working system 1 includes: a plurality of working machines 10 each configured to autonomously travel in a work area AR to work using electric equipment (electric (work) motor 22) mounted thereon, while rotating a blade 20; a standby (charge) ST 76 provided in the work area AR, in which each of the plurality of working machines 10 is docked; a signal generator 1a configured to generate a signal for each of the plurality of working machines 10 to set its travel route; a state detecting unit 1b configured to determine whether all of the plurality of working machines 10 are docked in the standby STs 76; and a managing unit 1c configured to restrict an operation of the signal generator 1a when the state detecting unit 1b determines that all of the plurality of working machines 10 are docked in the standby STs 76. With this configuration, the power consumption can be effectively reduced.

The standby ST 76 charges each of the plurality of working machines 10 docked in the standby STs 76. The state detecting unit 1b determines whether all of the plurality of working machines 10 are docked in the standby STs (charge STs) 76 on the basis of the magnitude of the currents respectively passed from the standby STs 76 through the plurality of working machines 10. As a result, it is possible to determine accurately whether the working machines 10 are docked in the standby STs 76.

The number of the standby STs 76 that match the number of the working machines 10 are provided. In this case, it is determined whether the passed current is a predetermined value (for example, 0.5 A) or more in all of the standby STs 76, and thus it possible to determine whether all of the working machines 10 are docked in the standby STs 76. The signal generator 1a generates a magnetic field signal that defines the work area AR via the area wire 72. With this magnetic field signal, each working machine 10 is able to recognize the work area AR and set an appropriate travel route.

The charge (standby) ST 76 is provided in the work area AR and charges each of the plurality of working machines 10 docked in the charge ST. Each of the plurality of working machines 10 autonomously travels in the work area AR to work using electric equipment (work motor 22) mounted thereon. The standby ST 76 includes the signal generator 1a that generates a signal for each of the plurality of working machines 10 to set its travel route, the state detecting unit 1b that determines whether all of the plurality of working machines 10 are docked in the standby STs 76, and the managing unit 1c that restricts an operation of the signal generator 1a, when the state detecting unit 1b determines that all of the plurality of working machines 10 are docked in the standby STs 76. With this configuration, the power consumption can be effectively reduced.

### Second Embodiment

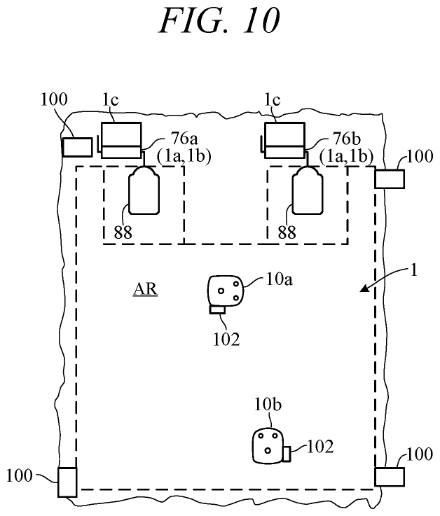

FIG. 10 is a top view schematically showing an overall configuration of a working system according to a second embodiment of the present invention.

The following explanation relates chiefly to points of difference from the first embodiment. In the working system 1 according to the second embodiment, in place of the area wire 72, a plurality of beacon signal generators 100 and the like disposed in the vicinity of the work area AR, more specifically, disposed at a predetermined separation distance from each other is used as the signal generator 1a that generates a signal for the working machine 10 to set its route.

The beacon signal generator 100 is a device that transmits a signal such as a radio wave (or light) toward the surroundings, and a reception terminal 102 that receives a signal transmitted from the beacon signal generator 100 is mounted on each of the working machines 10a and 10b.

The ECU 44 mounted on each of the working machines 10a and 10b detects the position of the work area AR on the basis of an output of the reception terminal 102, and sets its route. In addition, the relative position of the working machine 10 with respect to the work area AR is detected from the outputs of the drive wheel rotation sensor 56, the angular velocity sensor 46, the acceleration sensor 50, and the azimuth sensor 52. The GPS receiver 54 may be of a satellite positioning system type using a satellite other than GPS satellites, such as a global navigation satellite system (GNSS) or a regional navigation satellite system (RNSS).

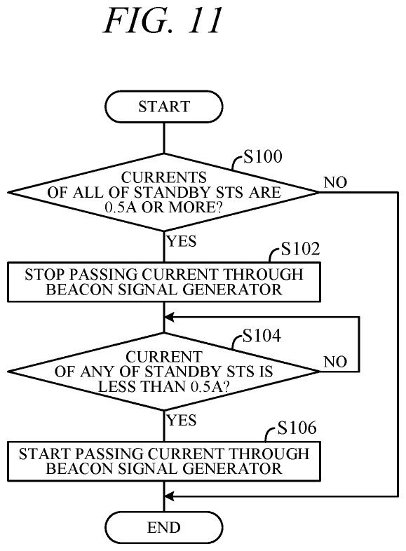

FIG. 11 is a flowchart showing an example of a process performed by the working system 1 according to the second embodiment of the present invention, and is a flowchart showing an example of a process performed by the state detecting unit 1b (charge ECU 84b and the like) according to a predetermined program.

As shown in FIG. 11, first, in S100, it is determined whether the currents passed from the charge terminals 86 of all of the standby STs 76a and 76b through the battery charge terminals 34 are 0.5 A or more. If the determination in S100 is NO, the process ends. If the determination in S100 is YES, the process proceeds to S102, and stops passing the current through the beacon signal generator 100 in accordance with a command from the managing unit 1c so as to restrict the operation of the signal generator 1a. Next, the process proceeds to S104, and it is determined whether the current passed from the charge terminal 86 of one of the standby STs 76a and 76b through the battery charge terminal 34 is less than 0.5 A. S104 is repeated until it is affirmed. If the determination in S104 is YES, the process proceeds to S106, and starts (or restarts) passing a current through the beacon signal generator 100 in accordance with a command from the managing unit 1c so as to release the operation restriction of the signal generator 1a.

When the working machine 10 returns to the standby ST 76 and connects (docks) therewith through the charge terminal 86 and the battery charge terminal 34, a current of 0.5 A or more flows from the charge terminal 86 to the battery charge terminal 34 of the working machine 10 regardless of the presence or absence of charge. Thus, if the currents passed from all of the standby STs 76a and 76b are 0.5 A or more, all of the working machines 10a and 10b are docked in the standby STs 76 and are not located in the work area AR. In this case, passing the current through the beacon signal generator 100 is stopped and the operation of the signal generator 1a is restricted, which makes it possible to effectively reduce the power consumption. Instead of stopping passing the current through the beacon signal generator 100, the frequency and strength of generation of the beacon signal may be restricted. At this time, further, the current passed through the reception terminal 102 of the working machine 10 that receives the beacon signal may also be stopped. In this case, the power consumption can be more effectively reduced.

On the other hand, if the current passed from one of the standby STs 76a and 76b is less than 0.5 A, one of the working machines 10a and 10b is not docked in the standby ST 76 and is located in the work area AR. In this case, passing a current through the beacon signal generator 100 is started and the operation restriction of the signal generator 1a is released, which makes it possible to prevent trouble from occurring during travel of the working machine 10 located in the work area AR.

The second embodiment can achieve advantageous effects as follows.

A working system 1 includes: a plurality of working machines 10 each configured to autonomously travel in a work area AR to work using electric equipment (electric (work) motor 22) mounted thereon, while rotating a blade 20; a standby (charge) ST 76 provided in the work area AR, in which each of the plurality of working machines 10 is docked; a signal generator 1a (beacon signal generator 100) configured to generate a signal for each of the plurality of working machines 10 to set its travel route; a state detecting unit 1b configured to determine whether all of the plurality of working machines 10 are docked in the standby STs 76; and a managing unit 1c configured to restrict an operation of the signal generator 1a when the state detecting unit 1b determines that all of the plurality of working machines 10 are docked in the standby STs 76. With this configuration, the power consumption can be effectively reduced.

On the other hand, if the current passed from one of the standby STs 76a and 76b is less than 0.5 A and one of the working machines 10a and 10b is not docked in the standby ST 76 and is located in the work area AR, passing a current through the beacon signal generator 100 is started so as to release the operation restriction of the signal generator 1a. This makes it possible to prevent trouble from occurring during travel of the working machine 10 located in the work area AR.

### Third Embodiment

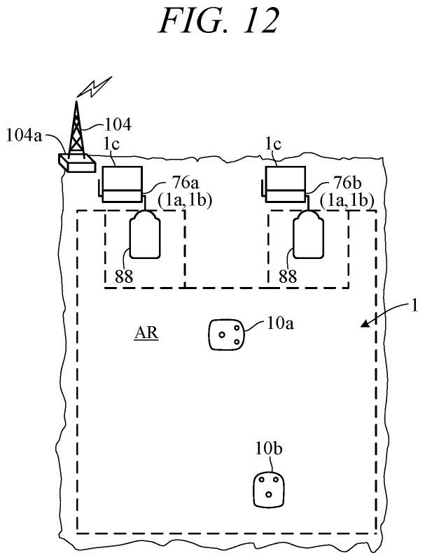

FIG. 12 is a top view schematically showing an overall configuration of a working system according to a third embodiment of the present invention.

The following explanation relates chiefly to points of difference from the first embodiment. In the working system 1 according to the third embodiment, in place of the area wire 72, a relay reception unit 104 that is disposed in the vicinity (inside or outside) of the work area AR and that receives and relays a satellite radio wave signal indicating the position of the working machine 10 is used as the signal generator 1a that generates a signal for the working machine 10 to set its route.

The relay reception unit 104 includes an antenna that receives a satellite radio wave signal, and a base body 104a that supports the antenna. A control circuit (a receiver that receives the satellite radio wave signal via the antenna, an amplifier that amplifies a signal, a transmitter that transmits a signal to the working machine 10, and the like) is accommodated in the base body 104a.

The GPS receiver 54 mounted on each of the working machines 10a and 10b receives the satellite radio wave signal relayed by the relay reception unit 104, and generates an output indicating the current position (latitude, longitude) of the working machine 10. The ECU 44 detects the position of the working machine 10 in the work area AR from the output of the GPS receiver 54, and sets its route. In addition, the relative position of the working machine 10 in the work area AR is detected from the outputs of the drive wheel rotation sensor 56, the angular velocity sensor 46, the acceleration sensor 50, and the azimuth sensor 52. At this time, the area wire 72 may be detected and used in a supplemental manner. The relay reception unit 104 may relay a satellite radio wave signal from a GPS satellite, or may relay another satellite radio wave signal.

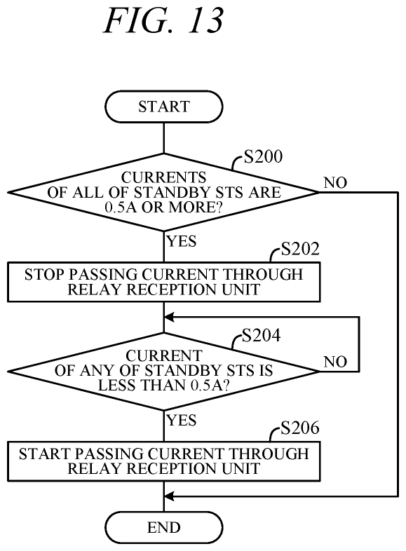

FIG. 13 is a flowchart showing an example of a process performed by the working system 1 according to the third embodiment of the present invention, and is a flowchart showing an example of a process performed by the state detecting unit 1b (charge ECU 84b and the like) according to a predetermined program.

As shown in FIG. 13, first, in S200, it is determined whether the currents passed from the charge terminals 86 of all of the standby STs 76a and 76b through the battery charge terminals 34 are 0.5 A or more. If the determination in S200 is NO, the process ends. If the determination in S200 is YES, the process proceeds to S202, and stops passing the current through the relay reception unit 104 in accordance with a command from the managing unit 1c so as to restrict the operation of the signal generator 1a. Instead of stopping passing the current through the entire relay reception unit 104, for example, the current passed only through the amplifier may be stopped so as to restrict the operation of the signal generator 1a.

Next, the process proceeds to S204, and it is determined whether the current passed from the charge terminal 86 of one of the standby STs 76a and 76b through the battery charge terminal 34 is less than 0.5 A. S204 is repeated until it is affirmed. If the determination in S204 is YES, the process proceeds to S206, and starts (or restarts) passing a current through the relay reception unit 104 in accordance with a command from the managing unit 1c so as to release the operation restriction of the signal generator 1a.

When the working machine 10 returns to the standby ST 76 and connects (docks) therewith through the charge terminal 86 and the battery charge terminal 34, a current of 0.5 A or more flows from the charge terminal 86 to the battery charge terminal 34 of the working machine 10 regardless of the presence or absence of charge. Thus, if the currents passed from all of the standby STs 76a and 76b are 0.5 A or more, all of the working machines 10a and 10b are docked in the standby STs 76 and are not located in the work area AR. In this case, passing the current through the relay reception unit 104 is stopped and the operation of the signal generator 1a is restricted, which makes it possible to effectively reduce the power consumption. On the other hand, if the current passed from one of the standby STs 76a and 76b is less than 0.5 A, one of the working machines 10a and 10b is not docked in the standby ST 76 and is located in the work area AR. In this case, passing a current through the relay reception unit 104 is started and the operation restriction of the signal generator 1a is released, which makes it possible to prevent trouble from occurring during travel of the working machine 10 located in the work area AR.

The third embodiment can achieve advantageous effects as follows.

A working system 1 includes: a plurality of working machines 10 each configured to autonomously travel in a work area AR to work using electric equipment (electric (work) motor 22) mounted thereon, while rotating a blade 20; a standby (charge) ST 76 provided in the work area AR, in which each of the plurality of working machines 10 is docked; a signal generator 1a (relay reception unit 104) configured to generate a signal for each of the plurality of working machines 10 to set its travel route; a state detecting unit 1b configured to determine whether all of the plurality of working machines 10 are docked in the standby STs 76; and a managing unit 1c configured to restrict an operation of the signal generator 1a when the state detecting unit 1b determines that all of the plurality of working machines 10 are docked in the standby STs 76. With this configuration, the power consumption can be effectively reduced.

On the other hand, if the current passed from one of the standby STs 76a and 76b is less than 0.5 A and one of the working machines 10a and 10b is not docked in the standby ST 76 and is located in the work area AR, passing a current through the relay reception unit 104 is started so as to release the operation restriction of the signal generator 1a. This makes it possible to prevent trouble from occurring during travel of the working machine 10 located in the work area AR.

### Fourth Embodiment

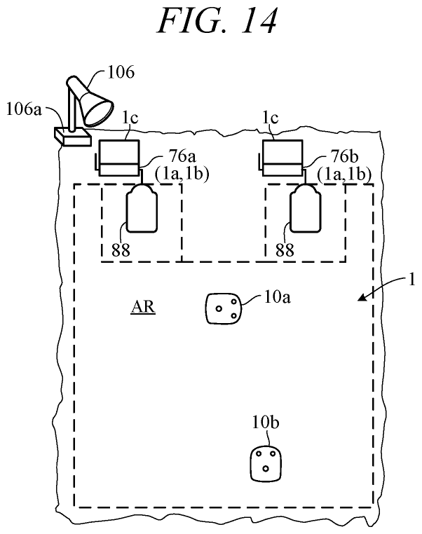

FIG. 14 is a top view schematically showing an overall configuration of a working system according to a fourth embodiment of the present invention.

The following explanation relates chiefly to points of difference from the first embodiment. In the working system 1 according to the fourth embodiment, in place of the area wire 72, an information acquiring unit 106 and the like disposed in the vicinity (inside or outside) of the work area AR for acquiring information regarding the work area AR or the working machines 10 in the work area and for generating a signal for each working machine 10 to set its travel route on the basis of the information acquired is used as the signal generator 1a that generates a signal for the working machine 10 to set its route.

The information acquiring unit 106 includes, for example, a monitoring camera that captures an image of the entire work area AR including the working machines 10 in the work area AR, and a base body 106a that supports the monitoring camera. A control circuit (ECU) or the like is accommodated inside the base body 106a, processes the captured image from the monitoring camera to detect the relative position of the working machine 10 in the work area AR, and transmits the detected position information (signal) to each working machine 10. In this case, it is possible to grasp whether each working machine 10 is docked in the standby ST 76 or is located in the work area AR on the basis of the captured image. Thus, the state detecting unit 1b may be provided in the information acquiring unit 106.

The information acquiring unit 106 may be a sensor for detecting the state of soil and the state of plants in the work area AR. In this case, the information acquiring unit 106 specifies a place where the state of soil is not preferable, a place where plants are not grown, or the like, and transmits, to each working machine 10, information (signal) of a place where the working machine 10 should make a detour.

The ECU 44 mounted on each of the working machines 10a and 10b is configured to be connectable to the information acquiring unit 106, and sets the travel routes of the working machines 10a and 10b in the work area on the basis of the information from the information acquiring unit 106. At this time, the area wire 72 may be detected and used in a supplemental manner.

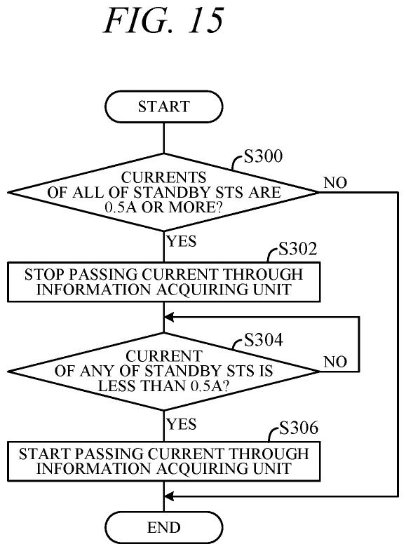

FIG. 15 is a flowchart showing an example of a process performed by the working system 1 according to the fourth embodiment of the present invention, and is a flowchart showing an example of a process performed by the state detecting unit 1b (charge ECU 84b and the like) according to a predetermined program.

As shown in FIG. 15, first, in S300, it is determined whether the currents passed from the charge terminals 86 of all of the standby STs 76a and 76b through the battery charge terminals 34 are 0.5 A or more. If the determination in S300 is NO, the process ends. If the determination in S300 is YES, the process proceeds to S302, and stops passing the current through the information acquiring unit 106 in accordance with a command from the managing unit 1c so as to restrict the operation of the signal generator 1a.

Next, the process proceeds to S304, and it is determined whether the current passed from the charge terminal 86 of one of the standby STs 76a and 76b through the battery charge terminal 34 is less than 0.5 A. S304 is repeated until it is affirmed. If the determination in S304 is YES, the process proceeds to S306, and starts (or restarts) passing a current through the information acquiring unit 106 in accordance with a command from the managing unit 1c so as to release the operation restriction of the signal generator 1a.

When the working machine 10 returns to the standby ST 76 and connects (docks) therewith through the charge terminal 86 and the battery charge terminal 34, a current of 0.5 A or more flows from the charge terminal 86 to the battery charge terminal 34 of the working machine 10 regardless of the presence or absence of charge. Thus, if the currents passed from all of the standby STs 76a and 76b are 0.5 A or more, all of the working machines 10a and 10b are docked in the standby STs 76 and are not located in the work area AR. In this case, passing the current through the information acquiring unit 106 is stopped and the operation of the signal generator 1a is restricted, which makes it possible to effectively reduce the power consumption. Instead of stopping passing the current through the information acquiring unit 106, the frequency and the time for acquiring the information may be restricted.

On the other hand, if the current passed from one of the standby STs 76a and 76b is less than 0.5 A, one of the working machines 10a and 10b is not docked in the standby ST 76 and is located in the work area AR. In this case, passing a current through the information acquiring unit 106 is started and the operation restriction of the signal generator 1a is released, which makes it possible to prevent trouble from occurring during travel of the working machine 10 located in the work area AR.

The fourth embodiment can achieve advantageous effects as follows.

A working system 1 includes: a plurality of working machines 10 each configured to autonomously travel in a work area AR to work using electric equipment (electric (work) motor 22) mounted thereon, while rotating a blade 20; a standby (charge) ST 76 provided in the work area AR, in which each of the plurality of working machines 10 is docked; a signal generator 1a (information acquiring unit 106) configured to generate a signal for each of the plurality of working machines 10 to set its travel route; a state detecting unit 1b configured to determine whether all of the plurality of working machines 10 are docked in the standby STs 76; and a managing unit 1c configured to restrict an operation of the information acquiring unit 106 when the state detecting unit 1b determines that all of the plurality of working machines 10 are docked in the standby STs 76. With this configuration, the power consumption can be effectively reduced.

On the other hand, if the current passed from one of the standby STs 76a and 76b is less than 0.5 A, and one of the working machines 10a and 10b is not docked in the standby ST 76 and is located in the work area AR, passing a current through the information acquiring unit 106 is started so as to release the operation restriction of the signal generator 1a. This makes it possible to prevent trouble from occurring during travel of the working machine 10 located in the work area AR.

### Fifth Embodiment

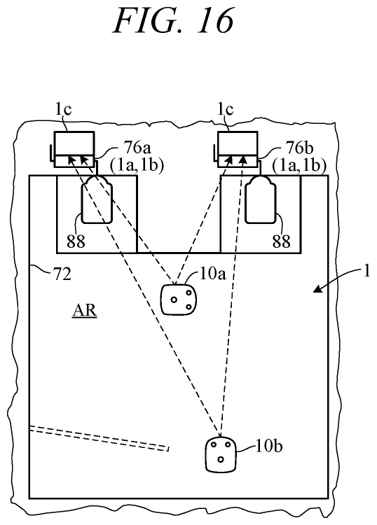

FIG. 16 is a top view schematically showing an overall configuration of a working system according to a fifth embodiment of the present invention.

The following explanation relates chiefly to points of difference from the first to fourth embodiments. In the working system 1 according to the fifth embodiment, the managing unit 1c receives the position information of the working machine 10 transmitted from the ECU 44 of the working machine 10.

The fifth embodiment can achieve advantageous effects as follows.

A working system 1 includes: a plurality of working machines 10 each configured to autonomously travel in a work area AR to work using electric equipment (electric (work) motor 22) mounted thereon, while rotating a blade 20; a standby (charge) ST 76 provided in the work area AR, in which each of the plurality of working machines 10 is docked; a signal generator 1a configured to generate a signal for each of the plurality of working machines 10 to set its travel route; a state detecting unit 1b configured to determine whether all of the plurality of working machines 10 are docked in the standby STs 76; and a managing unit 1c configured to restrict an operation of the signal generator 1a when the state detecting unit 1b determines that all of the plurality of working machines 10 are docked in the standby STs 76. With this configuration, the power consumption can be effectively reduced.

In addition, the managing unit 1c receives the position information of the working machine 10 transmitted from the ECU 44 of the working machine 10. Consequently, it is possible to grasp that the working machine 10 is located in the standby ST 76, that is, not located in the work area AR, even when it is difficult to accurately detect that the working machine 10 is located in the standby ST 76 on the basis of the state of the current passed from the charge terminal 86 through the battery charge terminal 34 of the working machine 10 due to a contact failure of the charge terminal or the like. In this case, the managing unit 1c restricts the operation of the signal generator 1a to reduce the power consumption and can also notify that there is a working machine 10 with a docking failure, for example.

The managing unit 1c may acquire identification information and work plan information of the working machine 10 in addition to the position information of the working machine 10 from the ECU 44 of the working machine 10. In this case, the managing unit 1c transmits the identification information and the work plan information of the working machine 10 to the charger 84, and the charger 84 conducts charge control according to the charge history and the work plan of the working machine 10. Thus, it is possible to prevent deterioration of the battery and unnecessary charge.

The managing unit 1c may always receive the position information of the working machine 10 from the ECU 44 of the working machine 10, or may receive the position information when the working machine 10 approaches the standby ST 76.

### Sixth Embodiment

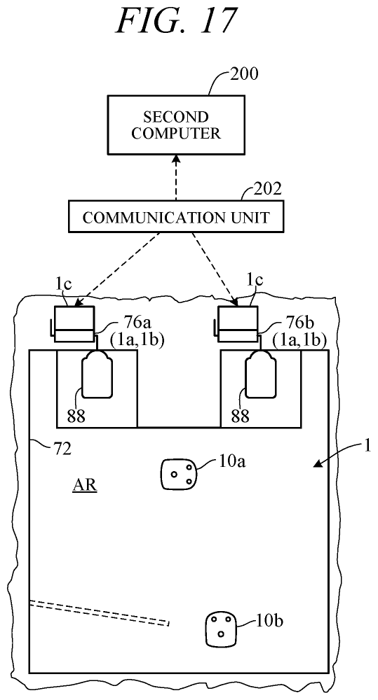

FIG. 17 is a top view schematically showing an overall configuration of a working system according to a sixth embodiment of the present invention.

The following explanation relates chiefly to points of difference from the first to fifth embodiments. The working system 1 according to the sixth embodiment further includes a communication unit 202 wirelessly connectable to an external device, and is configured to be mutually connectable to a second computer 200, which is the external device, through the communication unit 202. The managing unit 1c acquires, from the second computer 200, information indicating whether the working machine 10 is docked in the standby ST 76. The second computer 200 may be a large-sized server computer such as a mainframe in a cloud, or may be a desktop personal computer, a notebook personal computer, a mobile personal computer, or a portable data assistant (PDA), each having a memory capacity not as large as that of the server computer, or a mobile phone, a tablet terminal, or the like having a built-in execution environment of a program.

The information indicating whether the working machine 10 is docked in the standby ST 76 may be information that is past work plan information having been replied from the second computer 200 or may be information transmitted from the second computer 200 for the first time. The past work plan information has been acquired a predetermined time before (at the execution time of the built-in program of the ECU 44) and transmitted to the second computer 200 by the managing unit 1c itself.

The managing unit 1c may directly acquire information indicating whether the working machine 10 is docked in the standby ST 76 from the second computer 200, or may acquire the information via the working machine 10. In a case in which the second computer 200 is constituted of a large-capacity server computer, the second computer 200 is caused to perform a part of the process of the CPU 44a of the ECU 44. Thus, the computation load of the CPU 44a can be reduced.

The information indicating whether the working machine 10 is docked in the standby ST 76 may be the position information of the working machine 10, or may be the work plan information including a work time of the working machine 10.

The sixth embodiment can achieve advantageous effects as follows.

A working system 1 includes: a plurality of working machines 10 each configured to autonomously travel in a work area AR to work using electric equipment (electric (work) motor 22) mounted thereon, while rotating a blade 20; a standby (charge) ST 76 provided in the work area AR, in which each of the plurality of working machines 10 is docked; a signal generator 1a configured to generate a signal for each of the plurality of working machines 10 to set its travel route; a state detecting unit 1b configured to determine whether all of the plurality of working machines 10 are docked in the standby STs 76; and a managing unit 1c configured to restrict an operation of the signal generator 1a when the state detecting unit 1b determines that all of the plurality of working machines 10 are docked in the standby STs 76. With this configuration, the power consumption can be effectively reduced.

In addition, the second computer is caused to perform a part of the process of the CPU 44a of the ECU 44, and thus it is possible to reduce the computation load of the CPU 44a.

The working system 1 further includes the communication unit 202 wirelessly connectable to an external device, and is configured to be mutually connectable to the second computer 200 such as a server computer in a cloud through the communication unit 202. The managing unit 1c acquires, from the second computer 200, the information indicating whether the working machine 10 is docked in the standby ST, such as the work plan information including the position information of the working machine 10, the work time of the working machine 10, and the like. In this case, if the working machine 10 is stuck or stolen in the work area AR, the user acquires status information from the second computer 200 to quickly recognize the situation, and further acquires the position information. As a result, it becomes easy for the user to set the working machine 10. In addition, in a case in which the second computer 200 is constituted of a tablet terminal or the like, the user is able to register the work plan on the second computer 200, which increases the convenience.

Furthermore, the managing unit 1c is configured to be mutually connectable to the second computer 200 through the communication unit 202. When acquiring the position information of the working machine 10 from the second computer 200, the managing unit 1c can grasp whether the working machine 10 is located in the standby ST 76. Thus, it is possible to grasp that the working machine 10 is located in the standby ST 76, that is, not located in the work area AR, even when it is difficult to accurately detect that the working machine 10 is located in the standby ST 76 on the basis of the state of the current passed from the charge terminal 86 through the battery charge terminal 34 of the working machine 10 due to a contact failure of the charge terminal or the like. In this case, the managing unit 1c restricts the operation of the signal generator 1a to reduce the power consumption and can also notify that there is a working machine 10 with a docking failure, for example. In addition, when acquiring the identification information of the working machine 10 from the second computer 200, the managing unit 1c transmits the identification information of the working machine 10 to the charger 84, and the charger 84 conducts charge control according to the charge history and the work plan of the working machine 10. Thus, it is possible to prevent deterioration or unnecessary charge of the mounted battery (battery) 32.

Although the robotic working machines 10 for mowing the lawn have been described in the above embodiments, the working machine autonomously traveling and working using electric equipment that is mounted thereon while autonomously traveling in the work area is not limited to them. For example, the working machine may conduct work such as cleaning or tree care.

The above embodiment can be combined as desired with one or more of the aforesaid modifications. The modifications can also be combined with one another.

This invention can provide a working system that intends to reduce power consumption, in a case in which a plurality of working machines and a plurality of standby stations are included in one work area.

Above, while the present invention has been described with reference to the preferred embodiments thereof, it will be understood, by those skilled in the art, that various changes and modifications may be made thereto without departing from the scope of the appended claims.

1. A working system, comprising:
a plurality of working machine each configured to autonomously travel in a work area to work using an electric equipment mounted thereon;
a standby station provided in the work area, in which each of the plurality of working machine is docked;
a signal generator configured to generate a signal for each of the plurality of working machine to set its travel route;
a determining unit configured to determine whether all of the plurality of working machine are docked in the standby station; and
a managing unit configured to restrict operation of the signal generator when it is determined by the determining unit that all of the plurality of working machine are docked in the standby station.

2. The working system according to claim 1, wherein
the standby station is a charge station configured to charge each of the plurality of working machine docked in the standby station, wherein
the determining unit determines whether all of the plurality of working machine are docked in the standby station based on a magnitude of current flowing from the standby station to each of the plurality of working machine.

3. The working system according to claim 2, wherein
a number of the standby station and a number of the plurality of working machine match each other.

4. The working system according to claim 1, wherein
the signal generator generates a magnetic field signal for defining the work area through an area wire.

5. The working system according to claim 1, wherein
the signal generator generates a beacon signal for defining the work area through a beacon signal generator.

6. The working system according to claim 1, wherein
the signal generator relays a satellite radio wave signal for calculating a position of each of the plurality of working machine through a relay reception unit.

7. The working system according to claim 1, wherein
the signal generator acquires information regarding the work area or each of the plurality of working machine through an information acquiring unit and generates the signal for each of the plurality of working machine to set its travel route based on the information acquired.

8. The working system according to claim 1, wherein
the managing unit receives positional information of each of the plurality of working machine transmitted from each of the plurality of working machine.

9. The working system according to claim 1, further comprising:
a communication unit, wherein
the managing unit receives information regarding whether each of the plurality of working machine is docked in the standby station from a computer outside the working system through the communication unit.

10. A charge station provided in a work area and configured to charge each of a plurality of working machine docked in the charge station, each of the plurality of working machine being configured to autonomously travel in the work area to work using an electric equipment mounted thereon,
the charge station comprising:
a signal generator configured to generate a signal for each of the plurality of working machine to set its travel route;
a determining unit configured to determine whether all of the plurality of working machine are docked in the standby station; and
a managing unit configured to restrict operation of the signal generator when it is determined by the determining unit that all of the plurality of working machine are docked in the standby station.
